(19) United States
(12) Patent Application Publication
(10) Pub. No.: US 2026/0064982 A1
(43) Pub. Date: Mar. 5, 2026

(54) INTELLIGENTLY SUMMARIZING DECISION TREE LOGIC WITH LARGE LANGUAGE MODELS

(71) Applicant: Oracle International Corporation, Redwood Shores, CA (US)

(72) Inventors: Kash Mohammadi, Simi Valley, CA (US); Rajasekhar Attuluri, Santa Clara, CA (US); Antonio Vazquez, Guadalajara (MX)

(73) Assignee: Oracle International Corporation, Redwood Shores, CA (US)

(21) Appl. No.: 19/172,541

(22) Filed: Apr. 7, 2025

Related U.S. Application Data
(60) Provisional application No. 63/690,066, filed on Sep. 3, 2024.

(51) Int. Cl. G06F 40/40; G06N 5/01

(52) U.S. Cl. CPC G06F 40/40; G06N 5/01

(57) ABSTRACT

Systems, methods, and computer-readable media are provided for accessing a stored data structure representing a decision tree, determining a plurality of rows of text representing leaf nodes of the decision tree and a plurality of conditions that describe paths to the leaf nodes along with a label for the corresponding leaf node, generating a prompt including the plurality of rows of text and a request to generate a result comprising a natural language summary column, executing the prompt against a large language model, receiving a result comprising a natural language summary column, storing a first natural language summary of a first path from the natural language summary column in association with a first leaf node in the stored data structure, and storing a second natural language summary of a second path from the natural language summary column in association with a second leaf node in the stored data structure.

### CROSS-REFERENCE TO RELATED APPLICATIONS

This application claims the benefit of U.S. Provisional Application No. 63/690,066 filed Sep. 3, 2024. The entire disclosure of the aforementioned application is incorporated by reference herein in its entirety for all purposes.

### BACKGROUND

Multidimensional data describes complex relationships between parameters of data. Multidimensional data consists of lots of data in a tabular format that does not directly indicate the relationship between parameters. Therefore, it is difficult to understand the relationships between parameters of multidimensional data just by viewing the table itself. In analyzing a set of multidimensional data, multiple relationships between parameters may be relevant to an overall conclusion based on the multidimensional data, compounding the difficulty of the analysis.

### BRIEF SUMMARY

In some embodiments, a computer-implemented method includes accessing a stored data structure representing a decision tree, determining a plurality of rows of text representing leaf nodes of the decision tree and a plurality of conditions that describe paths to the leaf nodes along with a label for the corresponding leaf node, generating a prompt including the plurality of rows of text and a request to generate a result including a natural language summary column, executing the prompt against a large language model, receiving a result including a natural language summary column, storing a first natural language summary of a first path from the natural language summary column in association with a first leaf node in the stored data structure, and storing a second natural language summary of a second path from the natural language summary column in association with a second leaf node in the stored data structure.

In a particular embodiment, a computer-implemented method includes accessing a stored data structure that represents a decision tree stored to make recommendations for unlabeled data based at least in part on a set of labeled training data. The decision tree includes a plurality of leaf nodes along a plurality of paths. The computer-implemented method further includes determining a plurality of rows of text based at least in part on the stored data structure, each row of the plurality of rows representing a leaf node of the plurality of leaf nodes and includes a plurality of conditions that describe a path to the leaf node along with a label for the leaf node, each condition of the plurality of conditions representing a branching node along a path to the leaf node, the plurality of conditions are logically combined using a logical operator, generating a prompt including the plurality of rows of text and a request to generate a result including a natural language summary column, each row of the natural language summary column is requested to include a natural language summary of a corresponding path to a leaf node of the plurality of leaf nodes, executing the prompt against a large language model, receiving a particular result including a particular natural language summary column, storing a first particular natural language summary of a first path from the particular natural language summary column in association with a first leaf node in the stored data structure, and storing a second particular natural language summary of a second path from the particular natural language summary column in association with a second leaf node in the stored data structure.

In a further embodiment, the prompt further includes a request to generate a natural language summary of a plurality of paths to leaf nodes of the plurality of leaf nodes, the particular result further includes a narrative natural language summary, and the computer-implemented method further includes storing the narrative natural language summary in association with the stored data structure.

In the same or a different further embodiment, the computer-implemented method includes causing the display of a representation of the stored data structure including the first particular natural language summary displayed in association with the first leaf node.

In another embodiment that extends the particular embodiment or any further embodiment, the prompt further includes descriptions of a plurality of parameters for the conditions and a suggested condition to emphasize within the particular result.

In another embodiment that extends the particular embodiment or any further embodiment, the decision tree of the stored data structure was generated using logic to maximize the homogeneity of samples in each child node.

In another embodiment that extends the particular embodiment or any further embodiment, the prompt further includes a description of a target table including the natural language summary column and a target table condition column to identify the condition for each of the natural language summaries of the natural language summary column.

In another embodiment that extends the particular embodiment or any further embodiment, the computer-implemented method further includes detecting a delimiter text between column names of the particular result and determining the first particular natural language summary from the particular result based on the delimiter text.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart of an example process for data visualization.

FIG. 2 illustrates a system diagram showing an example cloud infrastructure of a data visualization system.

FIG. 3 illustrates a diagram of an example user interface for inputting data.

FIG. 4 illustrates an example decision tree visualization.

FIG. 5 illustrates an example large language model prompt.

FIG. 6 depicts a simplified diagram of a distributed system for implementing certain aspects.

FIG. 7 is a simplified block diagram of one or more components of a system environment by which services provided by one or more components of an embodiment system may be offered as cloud services, in accordance with certain aspects.

FIG. 8 illustrates an example computer system that may be used to implement certain aspects.

### DETAILED DESCRIPTION

A description is provided for visualizing tabular data parameter relationships in natural language descriptions of conditions within a decision tree generated from the tabular data. In various embodiments, the data visualization system is implemented using non-transitory computer-readable storage media to store instructions which, when executed by one or more processors of a computer system, cause display of the user interface and processing of the received input to visualize data. The data visualization system may be implemented on a local or cloud-based computer system that includes processors and a display for showing the user interface to a user for data visualization. The computer system may communicate with client computer systems for data visualization.

A description of a data visualization system is provided in the following sections:
GENERATION OF DECISION TREE
SUMMARIZING DECISION TREE CONDITIONS
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

### Generation of Decision Tree

Multidimensional data is data in a tabular format that contains multiple dimensions or parameters for each record of the data. Multidimensional data often contains valuable insights in the form of relationships between parameters of the data. Parameters of multidimensional data may describe data in a numerical, text, Boolean, or other format. Multidimensional data may be stored and received by the data visualization system in any tabular format such as a CSV file, XML file, JSON table, text files formatted to tabular format, or other tabular format file. An example table of multidimensional data is provided in Table 1.

TABLE 1

| | | | | | Distance | | | | | |
|---|---|---|---|---|---|---|---|---|---|---|
| | | Education | Experience | Previous | From | Interview | Skill | Personality | Recruitment | Hiring |
| Age | Gender | Level | Years | Companies | Company | Score | Score | Score | Strategy | Decision |
| 26 | 1 | 2 | 0 | 3 | 26.78 | 48 | 78 | 91 | 1 | Yes |
| 39 | 1 | 4 | 12 | 3 | 25.86 | 35 | 68 | 80 | 2 | Yes |
| 48 | 0 | 2 | 3 | 2 | 9.92 | 20 | 67 | 13 | 2 | No |
| 34 | 1 | 2 | 5 | 2 | 6.41 | 36 | 27 | 70 | 3 | No |
| 30 | 0 | 1 | 6 | 1 | 43.1 | 23 | 52 | 85 | 2 | No |
| 27 | 0 | 3 | 14 | 4 | 31.7 | 54 | 50 | 50 | 1 | Yes |
| 48 | 0 | 2 | 6 | 1 | 17.3 | 24 | 52 | 64 | 3 | No |
| 40 | 0 | 4 | 13 | 3 | 10.6 | 6 | 3 | 92 | 3 | No |
| 26 | 1 | 3 | 6 | 5 | 28.8 | 80 | 78 | 51 | 1 | Yes |
| 45 | 1 | 2 | 2 | 5 | 30.2 | 92 | 16 | 94 | 3 | No |
| 38 | 1 | 1 | 15 | 2 | 11.3 | 93 | 66 | 29 | 2 | No |
| 42 | 0 | 3 | 5 | 5 | 43.6 | 70 | 73 | 56 | 2 | No |
| 30 | 0 | 3 | 12 | 5 | 5.21 | 96 | 46 | 78 | 3 | Yes |
| 30 | 0 | 1 | 7 | 5 | 18.8 | 70 | 55 | 81 | 2 | No |
| 43 | 1 | 2 | 3 | 3 | 35.0 | 23 | 22 | 98 | 1 | No |

Direct searches in the table or looking up specific values for a given parameter, allows the user to view the relevant record(s) containing the specific values for the given parameter. However, this method of viewing multidimensional data does not provide insights into the relationship between parameters. For example, in Table 1, a user may look up records containing the highest value for the “Previous Companies” parameter, 5. For the four records containing a Previous Companies value of 5, the user would not be able to determine a correlation with a desired output of a specific “Hiring Decision” value.

In order to digest tabular data into a format that describes the relationships between parameters, a decision tree may be generated for the tabular data. A decision tree is a set of connected nodes where each node branches to a plurality of other nodes which represent conditions of a conditional logical statement on parameters of the data. A target parameter is selected for the decision tree, which will be analyzed as the output of the conditional logical statements. For example, if a user desired to determine the logical conditions that affect a “Hiring Decision” parameter in the above data, then the “Hiring Decision” parameter is selected as the target parameter.

In defining a target parameter, a target value or target range may also be defined. A target value may be a possible value within the target parameter from which a distance may be defined for values of the target parameter. In generating the decision tree, a distance measure may be calculated from the target value to determine if the set of conditions for a record is close or far from the desired outcome. A target range may also be defined including a target value and a farthest possible value. By default, a target range may be defined by a largest and smallest value within the table for the target parameter. In another embodiment, the target range may be normalized such that a measure of distance from or improvement toward the desired outcome may be more easily determined. For example, if the desired outcome seeks to maximize the values of the target parameter up to the target value, all values of the target parameter may be divided by the target value to normalize the target parameter.

In one embodiment, a plurality of component target parameters may be analyzed by first defining a combined target parameter that converts each of the plurality of component target parameters into a single target parameter. For example, a combined target parameter may be defined as an average of two different component target parameters. In defining an average, some parameter values may need to be altered such that, within the average, an improvement in one component target parameter will move the combined target parameter toward the indicated desired value. For example, if a first component target parameter's target value is a maximum value and a second component target parameter's target value is a minimum value, then the values of the second component target parameter may be inverted by dividing one by the values of the second component target parameter such that the resulting values trend toward a maximum second target parameter target value.

The average defined for the combined target parameter may be a weighted average such that the combined target parameter represents a stronger effect in achieving some parameters over other parameters. For example, in analyzing a set of data with component target parameters of a profit parameter and an expenses parameter, a user may determine that the profit parameter is twice as important to optimize as the expenses parameter. The average defined to generate a combined target parameter may be the sum of the expenses parameter and two times the profit parameter divided by three. This average definition will then, when applied to the data of each record for the component target parameters, will generate combined target parameter values to generate a combined target parameter.

A decision tree begins with a first conditional statement that determines a number of child nodes. Each node of a decision tree is a set of conditions on the tabular data. The decision tree terminates in a number of leaf nodes, nodes that define a final decision in a set of conditional statements of the parent nodes above it. Each leaf node may represent the set of conditions unique to a specific record of the tabular data.

To generate a decision tree, a decision tree model is applied to the tabular data. The decision tree model may be a machine learning model trained to generate a decision tree from tabular data based on a specific metric for creating nodes within the tree. A target parameter is specified to the decision tree model, which the decision tree model uses in generating nodes with conditional statements of the decision tree that create a logical condition on the target parameter.

The decision tree is generated based on a specific metric for creating nodes within the tree, such as a Gini coefficient, an entropy metric, a chi-square statistic, a mean squared error, or another metric used to determine where to split a decision tree to promote a balancing of outcomes in the tree. For example, the decision tree may generate nodes based on the Gini coefficient, a measure of how homogeneous the data of the target parameter can be split based on the numerical features of the data. The Gini coefficient may be described as 1ρpᵢ² where pᵢ represents the probability of a class, or target parameter value, in a node. In generating nodes based on the Gini coefficient, the decision tree model attempts to determine a set of logical conditions on the data for which the values of the target parameter are the most similar on either side of a conditional statement. For example, the above user inquiry to the “Previous Companies” parameter values equal to 5 would create a poor Gini coefficient as the number of “Yes” and “No” values for the “Hiring Decision” parameter are even for “Previous Companies” values of 5.

Alternatively, the decision tree may be generated based on an entropy metric. The entropy metric measures the uncertainty in a set of data where entropy reduces in two child nodes from a parent node when the child nodes better divide the records of each node into homogenous classes or values of the target parameter. The entropy may be defined as −Σpᵢ log₂ pᵢ, where pᵢ is the probability of a class, or target parameter value, within a node. In generating decision trees based on an entropy metric, the decision tree model attempts to determine the conditions for a pair of child nodes that have the lowest entropy and decrease the entropy of their parent node. A node for which no further reduction of entropy may be made by splitting the data becomes a leaf node of the decision tree.

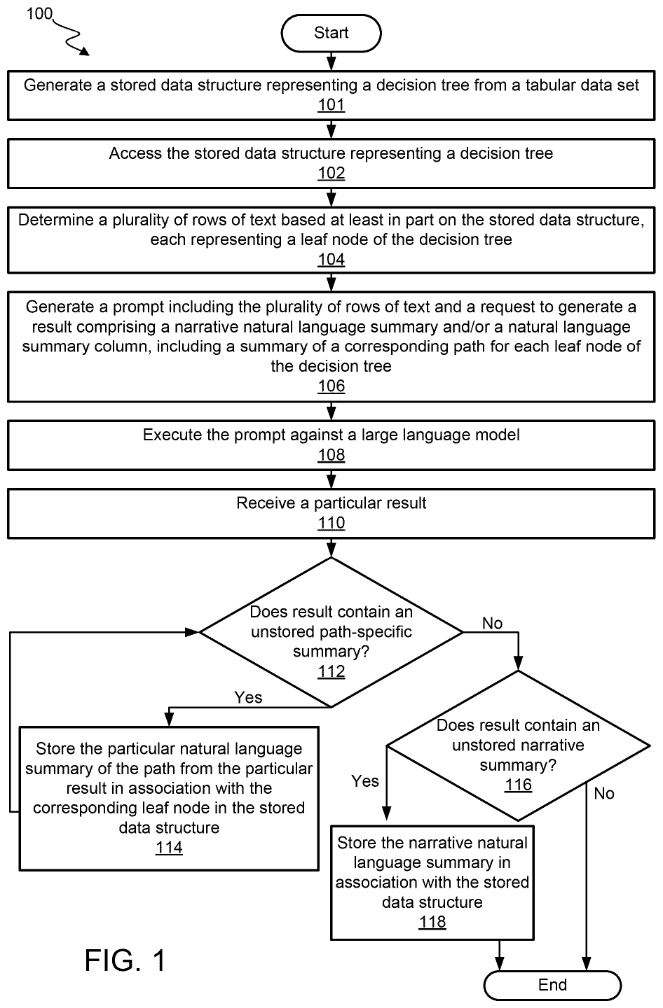

FIG. 1 depicts a flowchart representing a process for generating decision tree summaries. At block 101, a stored data structure representing a decision tree is generated from a tabular data set that represents conditions dividing outputs of a target parameter in the tabular data. At block 102, the stored data structure representing a decision tree is accessed. The stored data structure may be in a text format or may need to be converted into a text format such that, at block 104, a plurality of rows of text based at least in part on the stored data structure may be determined, where each row of text represents a leaf node of the decision tree. The rows of text may describe the path through the decision tree to access the leaf node it describes, including the conditions of the leaf node. At block 106, a prompt is generated including the plurality of rows of text and a request to generate a result comprising a natural language summary column, including a summary of a corresponding path for each leaf node of the decision tree. In addition or alternatively, the prompt may instead include a request to generate a result comprising a narrative language summary of the entire decision tree. At block 108 the prompt is executed against a large language model to generate the summary or summaries requested in the prompt. At block 110, a particular result is received, including the generated summary or summaries. Between block 112 and block 114, the system determines if there is a yet unprocessed summary for any individual row or leaf node of the decision tree and if so, the particular natural language summary of the path form the particular result is stored in association with the corresponding leaf node in the stored data structure and the same analysis of block 112 is repeated. After all path-specific summaries have been stored or the system determines, at block 112, that there are no path-specific summaries, at block 116 another analysis is made to determine if the result contains a narrative natural language summary for the entire decision tree. If so, at block 118, the narrative natural language summary is stored in association with the stored data structure. After which, or if there is no narrative summary, the processes ends.

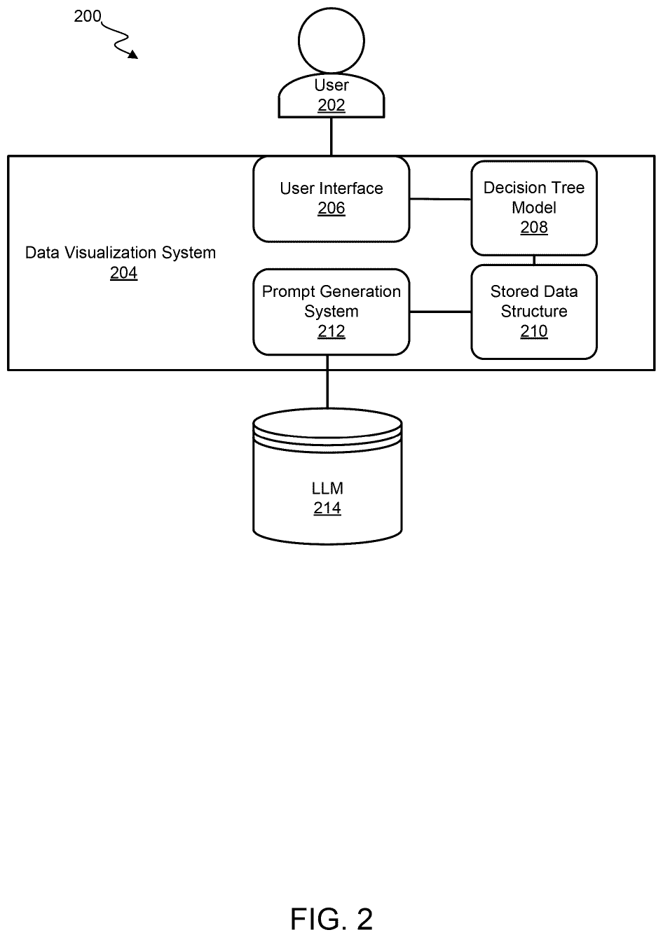

FIG. 2 depicts a system 200 for generating decision tree summaries. A user 202 enters tabular data into a data visualization system 204 via a user interface 206. The tabular data is used with a decision tree model 208 to generate a decision tree as a data structure which is stored as a stored data structure 210.

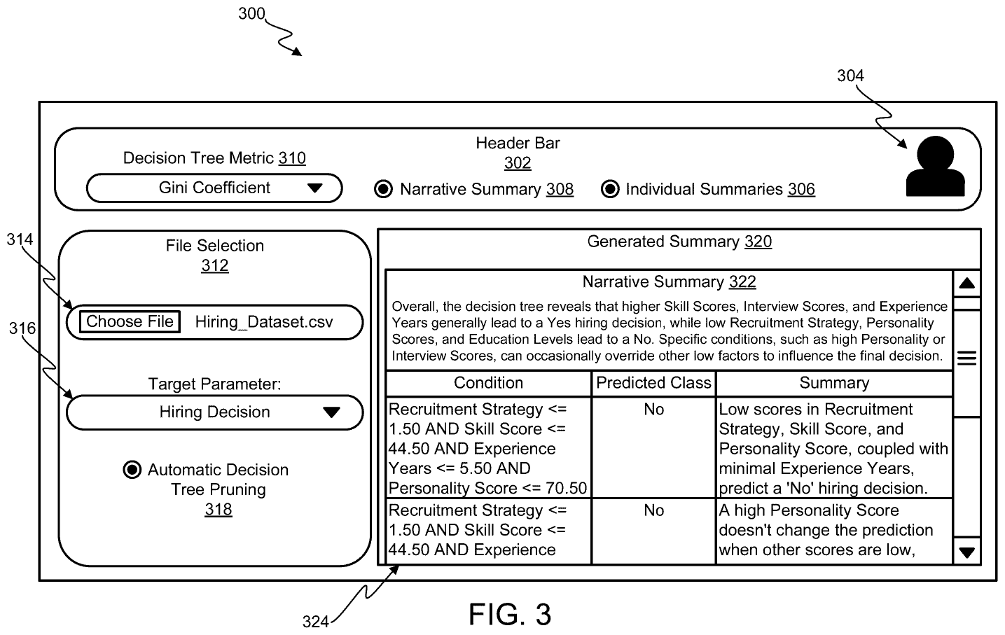

FIG. 3 depicts an example user interface 300 for receiving input to generate decision tree findings. The user interface 300 comprises a header bar 302 containing a plurality of settings for the user interface 300. The user interface may recognize a user 304 by a set of user credentials. The set of user credentials may determine the layout or displayed options for the user interface 300 as well as control access permission for the user interface 300. The user interface 300 comprises a plurality of settings 306-310 for the controlling the output of the user interface 300. The user interface 300 comprises an individual summaries setting 306 for toggling whether or not to generate individual summaries for each node of the generated decision tree. The user interface 300 also comprises a narrative summaries setting 308 for toggling whether or not to generate an overall narrative summary for the generated decision tree. The user interface 300 comprises a decision tree metric setting 310 for the user to select the metric the decision tree will apply in determining the conditions at a node of the decision tree at generation. The user interface also comprises a file selection region 312 for a user to make selections for the generation of a decision tree. The user interface comprises a data reception element 314 for the user to input tabular data to analyze and generate a decision tree from. The data reception element may be a window for entering data directly or may receive pre-existing data such as receiving a CSV file. The user interface 300 also comprises a target parameter selection 316 for selecting the target parameter of the selected data to compare via the selected decision tree metric. The user interface 300 may also comprise a number of settings for decision tree pruning 318 such as a setting to determine whether to automatically prune the decision tree. The user interface 300 comprises an output display region 320 for displaying the output summaries of the generated decision tree. The output display region 320 may display a narrative summary output 322 and/or an individual summary output 324. The narrative summary output 322 provides an output summary of the entire generated decision tree. The individual summary output 324 provides an output summary of individual nodes of the generated decision tree.

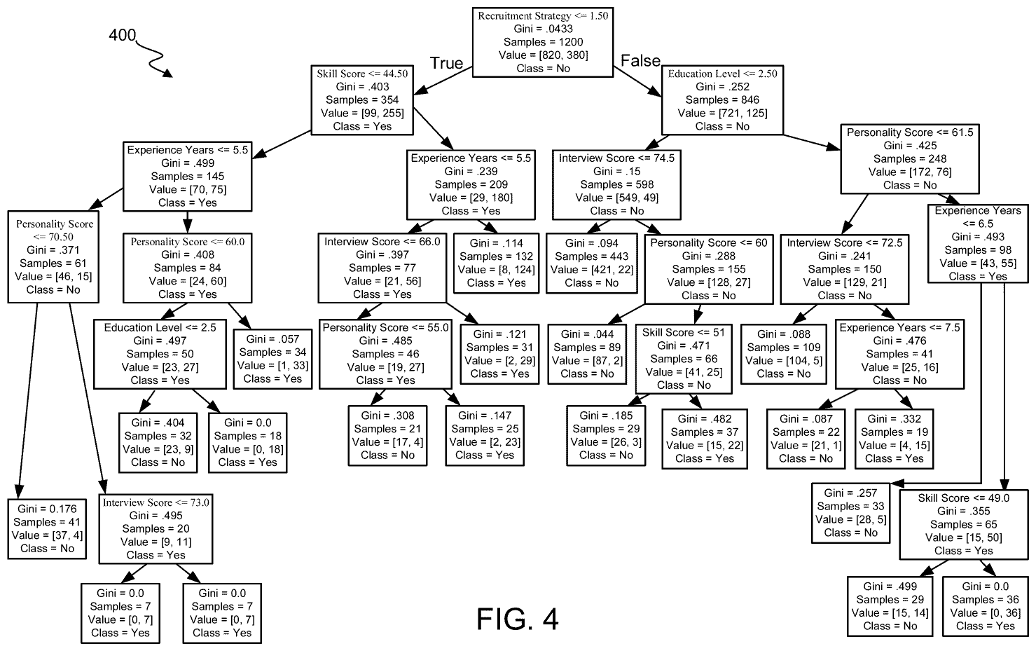

FIG. 4 depicts a decision tree 400 generated from the data of Table 1. Each ancestor node of the tree 400 sets a condition for which two child nodes represent the true and false outcome of that condition respectively. The decision tree 400 terminates in a number of leaf nodes, representing the combined condition of its ancestor nodes.

The decision tree may be output as a table of data where each record of the table is a path to a leaf node. In a decision tree where each node only has one parent node, there is only one path to each leaf node described in the decision tree table. A decision tree may contain nodes with more than one parent node, in which case multiple paths may be described for a single leaf node. The output decision tree table may be formatted as text data with formatting indicating the separate records and values of the table.

The decision tree may be output in another format, such as an image format or a structured data object. Such a decision tree may be parsed to generate a text format version of the data tree. For example, an algorithm may be defined to parse a structured data object and output the text data within the structured data object with text-based delimiters inserted for each detected connection between nodes.

Prior to generation of the decision tree, the data used to generate the decision tree may be filtered in a pre-pruning process. For example, the data may be parsed to determine duplicate entries which may be deleted or filtered such that only one instance remains in the data used to generate the decision tree. A given field of the data for each record of the data may be filtered out by checking the field against a set of rules to determine valid or invalid fields for decision tree generation. For example, a rule may specify a number of field titles or values of records within a field in a list of invalid fields for decision tree generation. The rule may be applied by parsing the field titles and record values for each field of the data and upon determining a match to a field title or record value of the list of invalid fields the field is filtered from the data prior to decision tree generation.

To generate accurate summaries of relationships within the data, the decision tree generated must first be accurate to the data. An inaccurate decision tree will lead to an inaccurate narrative summary of the data. As well, accurately generating narrative summaries may be more difficult as the size and complexity of the decision tree increase. In order to generate accurate narrative summaries of relationships within the data, the size of a decision tree may be reduced, so long as any reduction in accuracy of the decision tree does not offset the accuracy gain of generating a summary of a smaller decision tree.

After generation of the decision tree, the decision tree may be pruned to increase the accuracy and decrease the size of the decision tree. To prune a decision tree, a decision tree model may be used that applies a validation set to the decision tree. In pruning the decision tree using a validation set, some nodes may fit with the training set used for originally generating the decision tree but does not fit for the validation set. In this case, the nodes that do not fit for the validation set are pruned or removed such that the parent node becomes a leaf node.

A number of pruning methods may be used in pruning the tree. For example, a decision tree may be pruned using a cost-complexity pruning method that removes subtrees that do not contain a sufficient predictive power. In this example, a validation set may be used to calculate the metric for each parent node, such as the Gini Coefficient. The metric is used along with the number of nodes in the subtree to determine a cost-complexity criterion expressed as C_{α}(T)=R(T)+α·|T| where R(T) is the metric or error rate, |T| is the number of leaves in the subtree, and a is a tunable cost-complexity parameter to control the effect of tree size on the output of the criterion. If the cost-complexity criterion is above a certain threshold the subtree beginning at the parent node is pruned. In another example, a decision tree may be pruned using a reduced or minimum error pruning method that removes nodes that do not decrease the decision tree's accuracy when calculated using a validation set. In this example, at each node, beginning with the nodes above the leaf nodes, a calculation is performed of the accuracy of the decision tree with or without the branch descending from that node. If the accuracy does not increase, then the branch is pruned and the node is converted to a leaf node.

Alternatively, a decision tree may be pre-pruned by stopping the generation of the decision tree early to avoid unnecessary or non-predictive branches. For example, a rule may state a maximum depth of the decision tree such as a maximum number of branches and generation of a decision tree may be halted after a certain depth is reached. In another example, a rule may state a minimum number of samples within a node for a branch to be created from that node. A node may be checked against this rule first to determine if a further step to generate another branch from that node should be performed. In yet another example, a rule may state a minimum number of samples in a branching node when generating a branch. In this example, the output branch nodes may be compared to determine if they contain above the threshold minimum number of samples and if not, both branch nodes are deleted and the parent node is set as an leaf node of the decision tree.

The decision tree encodes relationships between the parameters that are determinative for the target parameter, however, the generated format for the decision tree may not be easily readable to a user. A natural language summary of the relationships between the parameters as determined within the decision tree should be created so as to aid the user's understanding of the relationship between the parameters.

### Prompting a Large Language Model

In one example, a configuration command may be provided to a query processing service in a user session or connection with a client to select a particular large language model for use with the natural language of incoming queries on a user session, or for given requests, from the client. For example, the “openai” large language model provider may be chosen with named credentials. The model used may be, for example, gpt-3.5-turbo. Other example providers include, but are not limited to, Cohere, Azure AI, Google PaLM 2, etc. In various other examples, default credentials may be used by the query processing service. In one embodiment, the credentials include user-specific credentials, such as a user-specific inner session identifier, that allow the LLM service to switch between supporting different users within the same LLM session using the same LLM connection credentials. In this embodiment, context from a given user may be retrieved using the user-specific inner session identifier before processing a natural language query for the given user. In another embodiment, an application uses the same LLM service for users but may use different LLM sessions for different users. The LLM session may be authenticated using a token that is established to refer to a particular user session. The token may be passed by the application to establish or re-establish the authenticated session with the LLM and begin sending prompts.

In various embodiments, prompts are generated to use information about a data schema of multidimensional data available in a user session with an application. The data schema may include dimension names, member names, and drill-down and roll-up hierarchies that are available to view or manipulate in the user session. The data schema may be formatted in a hierarchical format, such as JSON, XML, or another structured and delimited format that distinguishes between members at different levels of the hierarchy.

The prompts may also specify a format for providing the reply, through examples and/or through explicit description of the requested format.

In various embodiments, the techniques herein refer to “a prompt” being generated, and “the prompt” is intended to refer to a single request or multiple requests that, together, serve to prompt the LLM. LLMs may be prompted in a same session using one or multiple requests as the prompt to perform functionality, and the delineation between requests to the LLM can be split in any manner in accordance with the techniques described herein.

In one embodiment, validating the content of the LLM reply includes verifying that the reply conforms to the correct length and data type constraints, if any.

In various embodiments, the application may provide a configuration interface to the user for configuring a workflow for handling LLM replies that could not be validated. The configuration could specify that the LLM may be re-prompted with the non-validated reply used as a non-conforming example that should be avoided, or to trigger an error message.

In one embodiment, JSON results from the LLM are parsed by searching for delimiters such as {“and “}” or “[“and “]” in the response. The consumable JSON object may be separated from a remainder of the response for consumption by the application to create an executable structure to trigger application functionality.

### Summarizing Decision Tree Conditions

To generate a summary of the parameter relationships defined in the decision tree, a large language model is prompted to generate a natural language summary of each of the described parameter relationships. Returning to FIG. 2, the stored data structure 210 is passed to a prompt generation system 212. The prompt generation system 212 generates a prompt which is prompted against a large language model 214. The data visualization system 204 receives a response from the large language model 214. The response is used to create a visualization on the user interface 206 based on the response.

The prompt includes a set of instructions such that the large language model may properly interpret the data within the prompt and the output to be generated. The instructions may include a summary of the data that is included in the prompt. For example, the instructions may describe the decision tree table and the parameters that the decision tree describes. The instructions may also include the target parameter and the possible values or the range of values for the target parameter. The instructions may also include restrictions for the large language model to impose on the output, such as to not change any of the values or the words used within the decision table.

The instructions may also include suggested correlations between the data and data parameters. For example, the instructions may include a suggestion of a most important parameter that is the strongest determinative parameter for determining the output of the target parameter. In this case the large language model may assign a higher weight to describing the effect of the suggested parameter in a summary of conditions within the decision tree. Alternatively, the instructions may include a suggestion that two or more parameters are closely related to each other such that specific values of one of the parameters maps closely to specific values of another parameter. This may be a conclusion derived from a previous iteration of a decision tree analysis on the same set of data for a different target parameter.

The instructions may also include a description of the expected output. For example, the instructions may specify a table output with columns to output a condition of a specific leaf node and a corresponding summary of the conditions for that leaf node. Alternatively, the instructions may specify to generate a single, narrative, natural language summary for the decision tree, such as to describe the conditions that generate the highest Gini coefficient.

The prompt also includes data representing the generated decision tree. For example, the prompt may include decision tree paths to each leaf node in text format where each row of the table describes a path to a given leaf node. The path description in text format may describe a set of logical conditions where each conditional statement represents the conditional statement of an ancestor node of the leaf node and each conditional statement is separated by an AND operator.

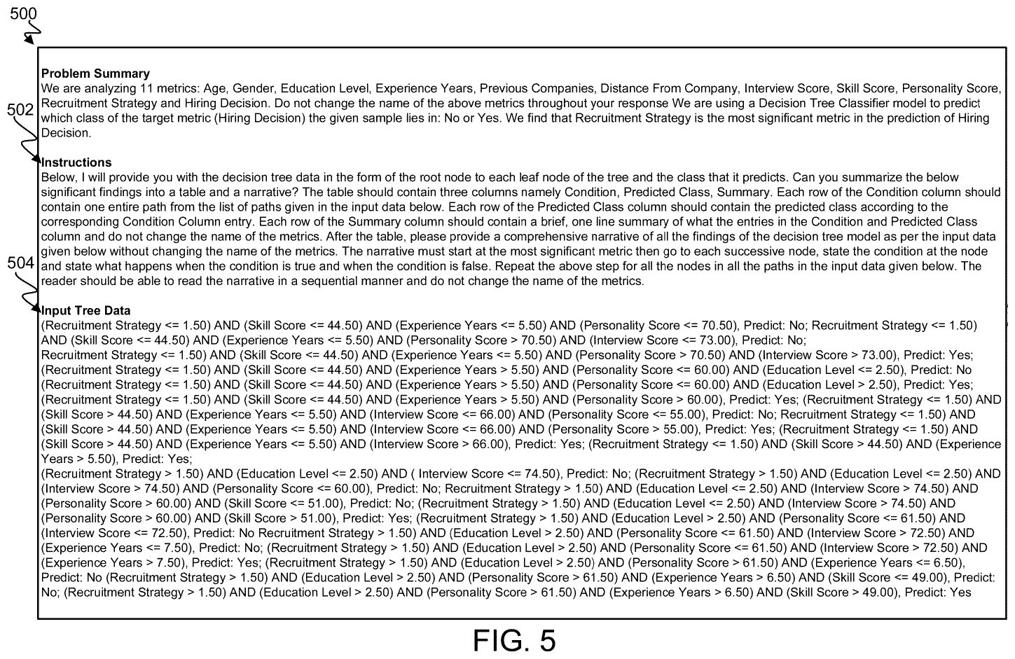

FIG. 5 depicts an example prompt 500 for using to prompt a large language model to generate a summary of the described decision tree. The prompt 500 includes instructions 502 describing the actions to perform using the decision tree data 504.

After generating the prompt, the prompt is used to prompt a large language model to generate the output. An example output of summaries is included in Table 2.

TABLE 2

| | Predicted | |
|---|---|---|
| Condition | Class | Summary |
| Recruitment Strategy <= 1.50 | No | Low scores in |
| AND Skill Score <= 44.50 AND | | Recruitment Strategy, |
| Experience Years <= 5.50 AND | | Skill Score, and |
| Personality Score <= 70.50 | | Personality Score, |
| | | coupled with minimal |
| | | Experience Years, |
| | | predict a ‘No’ |
| | | hiring decision. |
| Recruitment Strategy <= 1.50 | No | A high Personality Score |
| AND Skill Score <= 44.50 AND | | doesn't change the |
| Experience Years <= 5.50 AND | | prediction when other |
| Personality Score > 70.50 AND | | scores are low, leading |
| Interview Score <= 73.00 | | to a ‘No’ hiring |
| | | decision. |
| Recruitment Strategy <= 1.50 | Yes | However, a high |
| AND Skill Score <= 44.50 AND | | Interview Score |
| Experience Years <= 5.50 AND | | can flip the |
| Personality Score > 70.50 AND | | prediction to a |
| Interview Score > 73.00 | | ‘Yes' hiring decision. |
| Recruitment Strategy <= 1.50 | No | Still, focusing on low |
| AND Skill Score <= 44.50 AND | | Recruitment Strategy and |
| Experience Years > 5.50 AND | | Skill Score, coupled with |
| Personality Score <= 60.00 | | limited experience and |
| AND Education Level <= 2.50 | | education results in a |
| | | ‘No’ hiring decision. |
| Recruitment Strategy <= 1.50 | Yes | But, a higher Education |
| AND Skill Score <= 44.50 AND | | Level can change the |
| Experience Years > 5.50 AND | | outcome to a ‘Yes' |
| Personality Score <= 60.00 | | hiring decision |
| AND Education Level > 2.50 | | |
| Recruitment Strategy <= 1.50 | Yes | A high Personality Score, |
| AND Skill Score <= 44.50 AND | | despite other low scores, |
| Experience Years > 5.50 AND | | predicts a ‘Yes' hiring |
| Personality Score > 60.00 | | decision |
| Recruitment Strategy <= 1.50 | No | A moderate increase in |
| AND Skill Score > 44.50 AND | | Skill Score and a low |
| Experience Years <= 5.50 AND | | Personality Score leads |
| Interview Score <= 66.00 AND | | to a ‘No’ hiring |
| Personality Score <= 55.00 | | decision |
| Recruitment Strategy <= 1.50 | Yes | Yet, a high Personality |
| AND Skill Score > 44.50 AND | | Score sways the |
| Experience Years <= 5.50 AND | | prediction to a ‘Yes' |
| Interview Score <= 66.00 AND | | hiring decision |
| Personality Score > 55.00 | | |
| Recruitment Strategy <= 1.50 | Yes | Similarly, a high |
| AND Skill Score > 44.50 AND | | Interview Score also |
| Experience Years <= 5.50 AND | | predicts a ‘Yes' |
| Interview Score > 66.00 | | hiring decision |
| Recruitment Strategy <= 1.50 | Yes | A combination of higher |
| AND Skill Score > 44.50 AND | | scores in Skill and |
| Experience Years > 5.50 | | Experience Years results |
| | | in a definite ‘Yes' |
| | | hiring decision. |
| Recruitment Strategy > 1.50 | No | High Recruitment |
| AND Education Level <= 2.50 | | Strategy paired with |
| AND Interview Score <= 74.50 | | limited Education |
| | | Level and a low |
| | | Interview Score |
| | | predicts a ‘No’ |
| | | hiring decision. |
| Recruitment Strategy > 1.50 | No | A high Interview Score |
| AND Education Level <= 2.50 | | doesn't change the |
| AND Interview Score > 74.30 | | prediction with these |
| AND Personality Score <= 60.00 | | conditions. |
| Recruitment Strategy > 1.50 | No | But a low Skill Score |
| AND Education Level <= 2.50 | | keeps the prediction |
| AND Interview Score > 74.30 | | as ‘No’ even |
| AND Personality Score > 60.00 | | with a high |
| AND Skill Score <= 51.00 | | Personality Score. |
| Recruitment Strategy > 1.50 | Yes | Only when Skill Score is |
| AND Education Level <= 2.50 | | also high, the prediction |
| AND Interview Score > 74.30 | | flips to ‘Yes'. |
| AND Personality Score > 51.00 | | |
| Recruitment Strategy > 1.50 | No | High Recruitment |
| AND Education Level > 2.50 | | Strategy and a |
| AND Personality Score <= 61.50 | | moderate Interview |
| AND Interview Score <= 72.50 | | Score, coupled with |
| | | a low Personality |
| | | Score, results |
| | | in a ‘No’. |
| Recruitment Strategy > 1.50 | No | A low Personality Score, |
| AND Education Level > 2.50 | | despite other conditions, |
| AND Personality Score <= 61.50 | | predicts a ‘No’ hiring |
| AND Interview Score > 72.50 | | decision. |
| AND Experience Years <= 7.50 | | |
| Recruitment Strategy > 1.50 | Yes | However, sufficient |
| AND Education Level > 2.50 | | Experience Years |
| AND Personality Score <= 61.50 | | changes the |
| AND Interview Score > 72.50 | | prediction to |
| AND Experience Years > 7.50 | | a ‘Yes’. |
| Recruitment Strategy > 1.50 | No | High Personality Score |
| AND Education Level > 2.50 | | doesn't guarantee a ‘Yes’ |
| AND Personality Score > 61.50 | | decision with these |
| AND Experience Years <= 6.50 | | conditions. |
| Recruitment Strategy > 1.50 | No | A low Skill Score keeps |
| AND Education Level > 2.50 | | the prediction as ‘No’. |
| AND Personality Score > 61.50 | | |
| AND Experience Years > 6.50 | | |
| AND Skill Score <= 49.00 | | |
| Recruitment Strategy > 1.50 | Yes | But a high Skill Score, |
| AND Education Level > 2.50 | | along with other |
| AND Personality Score > 61.50 | | conditions, leads to |
| AND Experience Years > 6.50 | | a ‘Yes’ hiring |
| AND Skill Score > 49.00 | | decision |

Table 1 depicts a table of output summaries for each leaf node of a decision tree. The table includes a condition column to describe the logical condition of the leaf node, a column for a predicted outcome of the target parameter for the given condition, and the generated summary of the condition.

The prompt may also instruct the large language model to generate a narrative, natural language summary of the decision tree that covers a plurality of the leaf nodes or conditions of ancestor nodes. For example, a narrative description for the same decision tree as Table 1 may be:

“Now, let's narrate the findings in a sequential manner: Starting with the most significant metric, Recruitment Strategy, if it's less than or equal to 1.50, we see that candidates with low scores are more likely to be predicted a ‘No’ hiring decision. Conversely, those with scores above 1.50 are more likely to be predicted a ‘Yes’. Moving down the tree, we find that Skill Score is the next splits' condition. When it's<=44.50 and Recruitment Strategy is already <=1.50, a ‘No’ is further reinforced, except when Interview Score is high (>73.00), which tips the prediction to a ‘Yes’. If the Skill Score is >44.50, and other scores are moderate to low, the prediction remains a ‘Yes’. Next, considering Experience Years, when it's<=5.50 and other scores are low, the prediction stays a ‘No’. Only when Experience Years surpasses 5.50, the prediction changes to ‘Yes’. At this point, the model splits on Personality Score. A low score (<=60.00), maintains the ‘No’ prediction, while a high one (>60.00) flips it to ‘Yes’, regardless of other conditions. Education Level becomes relevant next. A maximum Education Level of 2.50, coupled with a low Interview Score, results in a ‘No’ prediction. This prediction persists unless the Interview Score is high (>74.50) and the Skill Score is also high (>51.00), in which case, the outcome changes to a ‘Yes’. For candidates with an Education Level of more than 2.50, the Personality Score comes into play. When it's low (<=61.50), the prediction is ‘No’, especially if Interview Score is low. However, a high Personality Score (>61.50) alters the decision to ‘Yes’ if Experience Years is sufficiently high (>7.50). The last node considers Experience Years again. Even with a high Personality Score, if Experience Years is minimal (<=6.50), the prediction stays ‘No’. It's only when Experience Years surpasses 6.50 and Skill Score is high (>49.00) that the model predicts a ‘Yes’ hiring decision. In conclusion, the model suggests that Recruitment Strategy and Skill Score are the most influential metrics, with candidates having high scores in these metrics and some supporting factors are most likely to be predicted a ‘Yes’. Conversely, those with low scores in these metrics are more likely to be predicted a ‘No’.”

### Prompting Large Language Model Using Ai Agents

The prompt used to prompt the large language model may be a prompt generated by an AI agent. One or more AI agents may be tasked with generating a summary of one or more parts of the decision tree. The AI agents may be trained to perform a specific task with regards to generating a summary of the decision tree such as parsing the decision tree or generating a prompt and prompting a large language model for generating summaries of parts of the decision tree.

The one or more AI agents may be specific to a certain type of data or use case. For example, an AI agent may be trained only using tabular data representing personal information of a plurality of people, in which case the AI agent may be specific to handling the generation of decision trees and summaries of decision trees relating to personal information or human resources use cases. The one or more AI agents may be selected by first determining a type of data or use case of the set of tabular data for generating the decision tree, then comparing the determined type of data or use case with a type of data or use case associated with the AI agent. The one or more AI agents may perform additional tasks prior to or after decision tree generation relevant to the type of data or use case of the AI agent. For example, an AI agent used for tables of personal data, the AI agent may perform an extra step prior to generating the decision tree of removing or masking any personally identifiable information. In another example, the same AI agent may, after generation of the decision tree, perform an extra pruning step after generation of the tree of pruning any subtrees indicating a bias based on personal characteristics or other excluded criteria.

The one or more AI agents may include a managing AI agent, which instantiates each of the one or more AI agents used in generating the summaries of the decision tree. The managing AI agent may determine a number of other AI agents necessary to generate summaries of the decision tree such as by parsing the tree and determining a number of sub-trees to be provided for another AI agent to use as a decision tree for the purpose of generating summaries. For example, a managing AI agent may determine a level or node of the tree that represents the most predictive power such as the node with the greatest Gini Coefficient. The managing AI agent may determine a number of subtrees from the determined level or node and may instantiate a number of AI agents that are each assigned a subtree for generating summaries of.

In another example, the managing agent may determine a set of features of each of the subtrees below a given node and determine a corresponding AI agent for each of the subtrees. In the example of the decision tree of FIG. 4, a managing agent may determine for the first node of the tree that either outcome of the Boolean operation of recruitment decision represents two different contexts of the hiring decision. The managing AI agent may then determine, based on the context, a corresponding AI agent for each of the subtrees descending from the first node which the managing AI agent may then instantiate and provide with their corresponding subtrees for generating summaries. The managing AI agent may then receive a response from each of the instantiated AI agents, generate a prompt for summarizing the first node of the tree, and combine the responses from the AI agents and the generated summary of the first node into a final set of summaries for output.

### Parsing and Displaying Output

The output summaries received from the large language model may be parsed or interpreted to generate a display for the user. The output of the large language model may be in a text format representing a summary or table of summaries. The data visualization system may need to interpret the output to display the summaries within the data visualization system.

The prompt may direct the large language model to generate a table including summaries for each condition of the leaf nodes. In this case the table may be parsed to detect each condition and associate the corresponding summary with the leaf node it describes. For example, the column titles defined within the prompt may be detected in the large language model's output to determine the delimiter used by the large language model to separate the columns of the title row. The determined delimiter may then be used in parsing the remainder of the output to determine each row and value for the output table. The determined rows and values may be stored either as a data object or as metadata to the stored data structure of the decision tree. The data visualization system may then display the decision tree to the user with the natural language summaries of each leaf node included.

Alternatively, the prompt may direct the large language model to generate a narrative, natural language summary of the entire decision tree. In this case the narrative summary may be displayed directly to the user. The natural language summary may also be parsed for key terms to determine the leaf node described in a part of the summary. The narrative summary may be displayed along with a choice to view further detail for any part of the summary by displaying the conditions for the leaf node described.

In yet another alternative, the prompt may direct the large language model to generate a natural language summary for each leaf node and a narrative, natural language summary for the entire decision tree. In this case, the output from the large language model may be parsed to detect the tabular summary and the narrative summary. The tabular summary and the narrative summary may then be stored separately within the data visualization system. For example, the natural language summary for the entire decision tree may be detected by detecting a narrative prefix used at the beginning of the natural language summary. The summary for the entire decision tree may be displayed to the user along with a choice to view further detail for any part of the summary by displaying the individual summary for each leaf node described in the part of the summary selected.

Output summaries for each leaf node and/or the narrative summary may further be used as input in a prompt to a large language model as a description of a decision process relevant to the prompt. For example, the output summaries may be included in a prompt with a set of conditions relevant to the decision process to generate a suggestion of changes to conditions or actions to take to achieve a desired outcome. In another example, the output summaries may be included in a prompt to a large language model along with a query to determine improvements to the decision process. In yet another example, the output summaries may be included in a prompt to a large language model along with a set of conditions and a query to estimate a likely outcome of applying the decision process.

When generating a prompt to a large language model including the output summaries, the prompt may include descriptive information about the parameters of the data described by the decision tree. The descriptive information about the parameters of the data may be definitions or descriptions of each of the parameters. Output summaries of a decision tree may be used to prompt a large language model to propose a course of action to improve the odds of a certain outcome according to the decision tree. In prompting the large language model with the output summaries, the prompt may label the parameters used in the data, such as with descriptions of the criteria that determine the data of each of the parameters. The prompt may also label whether any parameters or variables provided may be changed or altered in providing a proposed course of action. For example, the output summaries of Table 2 may be used to prompt a large language model to determine, for a number of values of each parameter for a given applicant, which values should be altered to increase the odds of resulting in a “Yes” hiring decision. In generating the prompt to the large language model for this example, the prompt may define the parameters such as “Interview Score: a numerical representation of an interviewer's impression of the applicant in an interview; Education Level, a numerical representation of the highest degree held by an applicant where 0=high school diploma, 1=undergraduate, 2=masters, and 3=doctorate degree.” The prompt may also identify parameters, such as age or gender, as values which may not be changed or that the large language model should not suggest or use in an output recommendation.

### Computer System Architecture

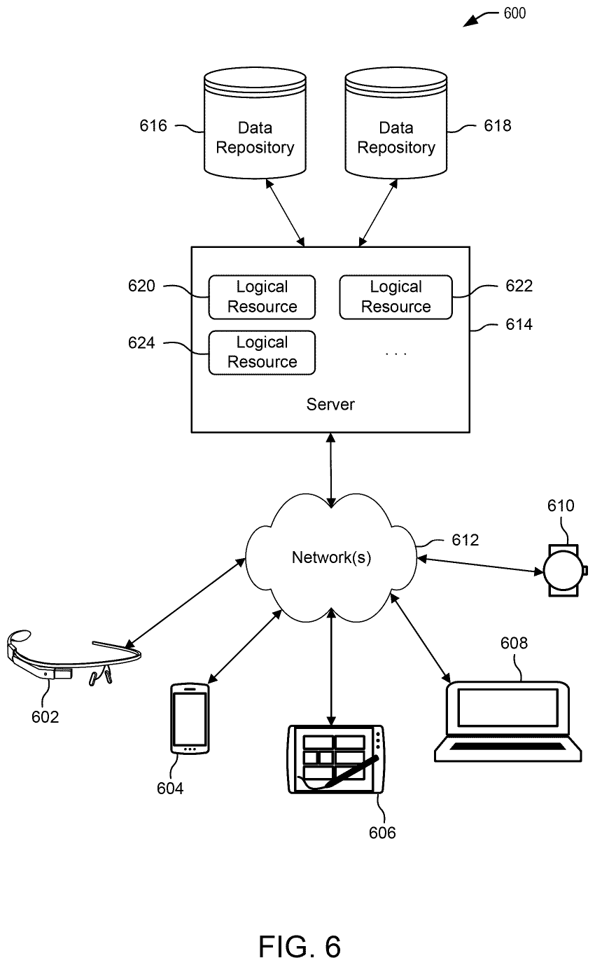

FIG. 6 depicts a simplified diagram of a distributed system 600 for implementing an embodiment. In the illustrated embodiment, distributed system 600 includes one or more client computing devices 602, 604, 606, 608, and/or 610 coupled to a server 614 via one or more communication networks 612. Clients computing devices 602, 604, 606, 608, and/or 610 may be configured to execute one or more applications.

In various aspects, server 614 may be adapted to run one or more services or software applications that enable techniques for data visualization.

In certain aspects, server 614 may also provide other services or software applications that can include non-virtual and virtual environments. In some aspects, these services may be offered as web-based or cloud services, such as under a Software as a Service (SaaS) model to the users of client computing devices 602, 604, 606, 608, and/or 610. Users operating client computing devices 602, 604, 606, 608, and/or 610 may in turn utilize one or more client applications to interact with server 614 to utilize the services provided by these components.

In the configuration depicted in FIG. 6, server 614 may include one or more components 620, 622 and 624 that implement the functions performed by server 614. These components may include software components that may be executed by one or more processors, hardware components, or combinations thereof. It should be appreciated that various different system configurations are possible, which may be different from distributed system 600. The embodiment shown in FIG. 6 is thus one example of a distributed system for implementing an embodiment system and is not intended to be limiting.

Users may use client computing devices 602, 604, 606, 608, and/or 610 for techniques for data visualization in accordance with the teachings of this disclosure. A client device may provide an interface that enables a user of the client device to interact with the client device. The client device may also output information to the user via this interface. Although FIG. 6 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google Assistant, Microsoft® Cortana®, Apple® Siri®, and others may be implemented on devices with a microphone and/or camera to receive user or environmental inputs, as well as a speaker and/or display to respond to the inputs. Wearable devices may include Apple Watch®, Samsung Galaxy Watch®, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 612 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 612 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth™, and/or any other wireless protocol), and/or any combination of these and/or other networks.

Server 614 may be composed of one or more general purpose computers, specialized server computers (including, by way of example, PC (personal computer) servers, UNIX® servers, LINIX® servers, mid-range servers, mainframe computers, rack-mounted servers, etc.), server farms, server clusters, a Real Application Cluster (RAC), database servers, or any other appropriate arrangement and/or combination. Server 614 can include one or more virtual machines running virtual operating systems, or other computing architectures involving virtualization such as one or more flexible pools of logical storage devices that can be virtualized to maintain virtual storage devices for the server. In various aspects, server 614 may be adapted to run one or more services or software applications that provide the functionality described in the foregoing disclosure.

The computing systems in server 614 may run one or more operating systems including any of those discussed above, as well as any commercially available server operating system. Server 614 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 614 may include one or more applications to analyze and consolidate data feeds and/or event updates received from users of client computing devices 602, 604, 606, 608, and/or 610. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 614 may also include one or more applications to display the data feeds and/or real-time events via one or more display devices of client computing devices 602, 604, 606, 608, and/or 610.

Distributed system 600 may also include one or more data repositories 616, 618. These data repositories may be used to store data and other information in certain aspects. For example, one or more of the data repositories 616, 618 may be used to store information for techniques for data visualization. Data repositories 616, 618 may reside in a variety of locations. For example, a data repository used by server 614 may be local to server 614 or may be remote from server 614 and in communication with server 614 via a network-based or dedicated connection. Data repositories 616, 618 may be of different types. In certain aspects, a data repository used by server 614 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 616, 618 may also be used by applications to store application data. The data repositories used by applications may be of different types such as, for example, a key-value store repository, an object store repository, or a general storage repository supported by a file system.

In one embodiment, server 614 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

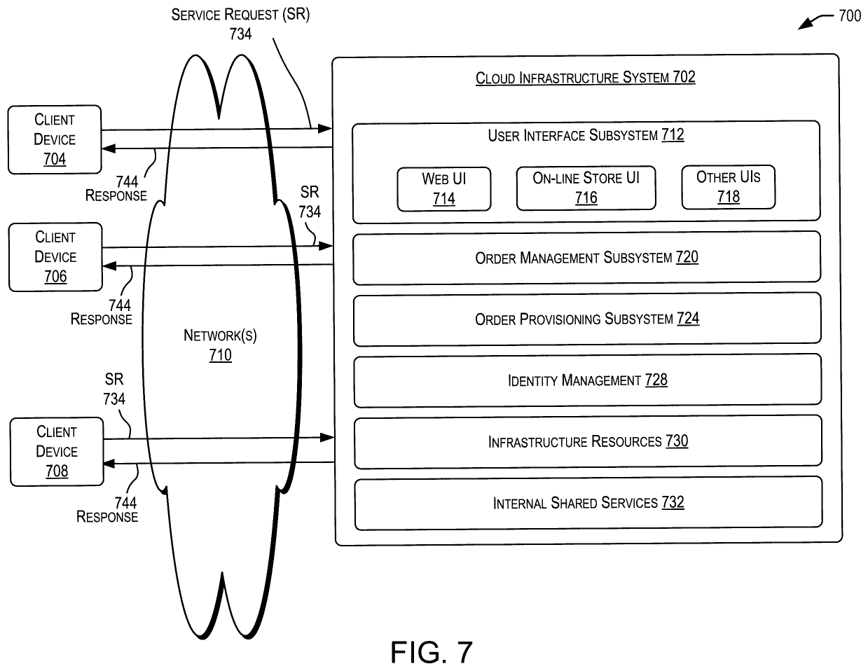

FIG. 7 is a simplified block diagram of a cloud-based system environment in which data is visualized, in accordance with certain aspects. In the embodiment depicted in FIG. 7, cloud infrastructure system 702 may provide one or more cloud services that may be requested by users using one or more client computing devices 704, 706, and 708. Cloud infrastructure system 702 may comprise one or more computers and/or servers that may include those described above for server 614. The computers in cloud infrastructure system 702 may be organized as general purpose computers, specialized server computers, server farms, server clusters, or any other appropriate arrangement and/or combination.

Network(s) 710 may facilitate communication and exchange of data between clients 704, 706, and 708 and cloud infrastructure system 702. Network(s) 710 may include one or more networks. The networks may be of the same or different types. Network(s) 710 may support one or more communication protocols, including wired and/or wireless protocols, for facilitating the communications.

The embodiment depicted in FIG. 7 is only one example of a cloud infrastructure system and is not intended to be limiting. It should be appreciated that, in some other aspects, cloud infrastructure system 702 may have more or fewer components than those depicted in FIG. 7, may combine two or more components, or may have a different configuration or arrangement of components. For example, although FIG. 7 depicts three client computing devices, any number of client computing devices may be supported in alternative aspects.

The term cloud service is generally used to refer to a service that is made available to users on demand and via a communication network such as the Internet by systems (e.g., cloud infrastructure system 702) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 710 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 702 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 702 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 702. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 702. Cloud infrastructure system 702 then performs processing to provide the services requested in the tenant's subscription order. Cloud infrastructure system 702 may be configured to provide one or even multiple cloud services.

Cloud infrastructure system 702 may provide the cloud services via different deployment models. In a public cloud model, cloud infrastructure system 702 may be owned by a third party cloud services provider and the cloud services are offered to any general public tenant, where the tenant can be an individual or an enterprise. In certain other aspects, under a private cloud model, cloud infrastructure system 702 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 702 and the services provided may be shared by several organizations in a related community. Various other models such as hybrids of the above mentioned models may also be used.

Client computing devices 704, 706, and 708 may be of different types (such as devices 602, 604, 606, and 608 depicted in FIG. 6) and may be capable of operating one or more client applications. A user may use a client device to interact with cloud infrastructure system 702, such as to request a service provided by cloud infrastructure system 702.

In some aspects, the processing performed by cloud infrastructure system 702 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 702 for determining the intent of an utterance. The data used for this analysis may include structured data (e.g., data stored in a database or structured according to a structured model) and/or unstructured data (e.g., data blobs (binary large objects)).

As depicted in the embodiment in FIG. 7, cloud infrastructure system 702 may include infrastructure resources 730 that are utilized for facilitating the provision of various cloud services offered by cloud infrastructure system 702. Infrastructure resources 730 may include, for example, processing resources, storage or memory resources, networking resources, and the like.

In certain aspects, to facilitate efficient provisioning of these resources for supporting the various cloud services provided by cloud infrastructure system 702 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 702 may itself internally use services 732 that are shared by different components of cloud infrastructure system 702 and which facilitate the provisioning of services by cloud infrastructure system 702. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 702 may comprise multiple subsystems. These subsystems may be implemented in software, or hardware, or combinations thereof. As depicted in FIG. 7, the subsystems may include a user interface subsystem 712 that enables users of cloud infrastructure system 702 to interact with cloud infrastructure system 702. User interface subsystem 712 may include various different interfaces such as a web interface 714, an online store interface 716 where cloud services provided by cloud infrastructure system 702 are advertised and are purchasable by a consumer, and other interfaces 718. For example, a tenant may, using a client device, request (service request 734) one or more services provided by cloud infrastructure system 702 using one or more of interfaces 714, 716, and 718. For example, a tenant may access the online store, browse cloud services offered by cloud infrastructure system 702, and place a subscription order for one or more services offered by cloud infrastructure system 702 that the tenant wishes to subscribe to. The service request may include information identifying the tenant and one or more services that the tenant desires to subscribe to. For example, a tenant may place a subscription order for a chatbot related service offered by cloud infrastructure system 702. As part of the order, the client may provide information identifying the input (e.g. utterances).

In certain aspects, such as the embodiment depicted in FIG. 7, cloud infrastructure system 702 may comprise an order management subsystem (OMS) 720 that is configured to process the new order. As part of this processing, OMS 720 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 720 may then invoke the order provisioning subsystem (OPS) 724 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 724 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 702 may send a response or notification 744 to the requesting tenant to indicate when the requested service is now ready for use. In some instances, information (e.g., a link) may be sent to the tenant that enables the tenant to start using and availing the benefits of the requested services.

Cloud infrastructure system 702 may provide services to multiple tenants. For each tenant, cloud infrastructure system 702 is responsible for managing information related to one or more subscription orders received from the tenant, maintaining tenant data related to the orders, and providing the requested services to the tenant or clients of the tenant. Cloud infrastructure system 702 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 702 may provide services to multiple tenants in parallel. Cloud infrastructure system 702 may store information for these tenants, including possibly proprietary information. In certain aspects, cloud infrastructure system 702 comprises an identity management subsystem (IMS) 728 that is configured to manage tenant's information and provide the separation of the managed information such that information related to one tenant is not accessible by another tenant. IMS 728 may be configured to provide various security-related services such as identity services, such as information access management, authentication and authorization services, services for managing tenant identities and roles and related capabilities, and the like.

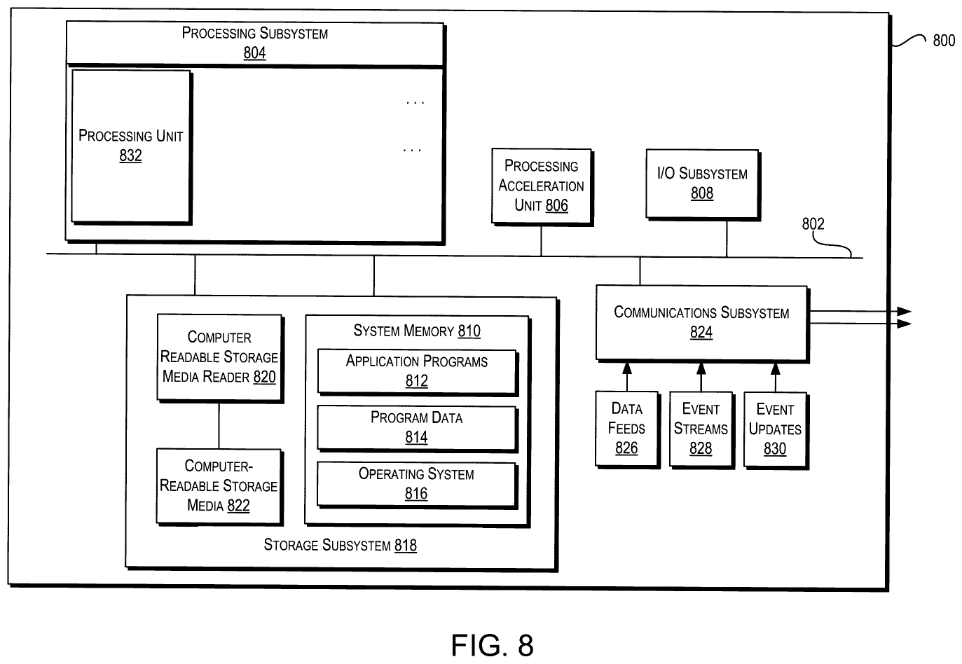

FIG. 8 illustrates an exemplary computer system 800 that may be used to implement certain aspects. As shown in FIG. 8, computer system 800 includes various subsystems including a processing subsystem 804 that communicates with a number of other subsystems via a bus subsystem 802. These other subsystems may include a processing acceleration unit 806, an I/O subsystem 808, a storage subsystem 818, and a communications subsystem 824. Storage subsystem 818 may include non-transitory computer-readable storage media including storage media 822 and a system memory 810.

Bus subsystem 802 provides a mechanism for letting the various components and subsystems of computer system 800 communicate with each other as intended. Although bus subsystem 802 is shown schematically as a single bus, alternative aspects of the bus subsystem may utilize multiple buses. Bus subsystem 802 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 804 controls the operation of computer system 800 and may comprise one or more processors, application specific integrated circuits (ASICs), or field programmable gate arrays (FPGAs). The processors may be single core or multicore processors. The processing resources of computer system 800 can be organized into one or more processing units 832, 834, etc. A processing unit may include one or more processors, one or more cores from the same or different processors, a combination of cores and processors, or other combinations of cores and processors. In some aspects, processing subsystem 804 can include one or more special purpose co-processors such as graphics processors, digital signal processors (DSPs), or the like. In some aspects, some or all of the processing units of processing subsystem 804 can be implemented using customized circuits, such as application specific integrated circuits (ASICs), or field programmable gate arrays (FPGAs).

In some aspects, the processing units in processing subsystem 804 can execute instructions stored in system memory 810 or on computer readable storage media 822. In various aspects, the processing units can execute a variety of programs or code instructions and can maintain multiple concurrently executing programs or processes. At any given time, some or all of the program code to be executed can be resident in system memory 810 and/or on computer-readable storage media 822 including potentially on one or more storage devices. Through suitable programming, processing subsystem 804 can provide various functionalities described above. In instances where computer system 800 is executing one or more virtual machines, one or more processing units may be allocated to each virtual machine.

In certain aspects, a processing acceleration unit 806 may optionally be provided for performing customized processing or for off-loading some of the processing performed by processing subsystem 804 so as to accelerate the overall processing performed by computer system 800.

I/O subsystem 808 may include devices and mechanisms for inputting information to computer system 800 and/or for outputting information from or via computer system 800. In general, use of the term input device is intended to include all possible types of devices and mechanisms for inputting information to computer system 800. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 800 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 818 provides a repository or data store for storing information and data that is used by computer system 800. Storage subsystem 818 provides a tangible non-transitory computer-readable storage medium for storing the basic programming and data constructs that provide the functionality of some aspects. Storage subsystem 818 may store software (e.g., programs, code modules, instructions) that when executed by processing subsystem 804 provides the functionality described above. The software may be executed by one or more processing units of processing subsystem 804. Storage subsystem 818 may also provide a repository for storing data used in accordance with the teachings of this disclosure.

Storage subsystem 818 may include one or more non-transitory memory devices, including volatile and non-volatile memory devices. As shown in FIG. 8, storage subsystem 818 includes a system memory 810 and a computer-readable storage media 822. System memory 810 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 800, such as during start-up, may typically be stored in the ROM. The RAM typically contains data and/or program modules that are presently being operated and executed by processing subsystem 804. In some implementations, system memory 810 may include multiple different types of memory, such as static random access memory (SRAM), dynamic random access memory (DRAM), and the like.

By way of example, and not limitation, as depicted in FIG. 8, system memory 810 may load application programs 812 that are being executed, which may include various applications such as Web browsers, mid-tier applications, relational database management systems (RDBMS), etc., program data 814, and an operating system 816. By way of example, operating system 816 may include various versions of Microsoft Windows®, Apple Macintosh®, and/or Linux operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 822 may store programming and data constructs that provide the functionality of some aspects. Computer-readable media 822 may provide storage of computer-readable instructions, data structures, program modules, and other data for computer system 800. Software (programs, code modules, instructions) that, when executed by processing subsystem 804 provides the functionality described above, may be stored in storage subsystem 818. By way of example, computer-readable storage media 822 may include non-volatile memory such as a hard disk drive, a magnetic disk drive, an optical disk drive such as a CD ROM, digital video disc (DVD), a Blu-Ray® disk, or other optical media. Computer-readable storage media 822 may include, but is not limited to, Zip® drives, flash memory cards, universal serial bus (USB) flash drives, secure digital (SD) cards, DVD disks, digital video tape, and the like. Computer-readable storage media 822 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 818 may also include a computer-readable storage media reader 820 that can further be connected to computer-readable storage media 822. Reader 820 may receive and be configured to read data from a memory device such as a disk, a flash drive, etc.

In certain aspects, computer system 800 may support virtualization technologies, including but not limited to virtualization of processing and memory resources. For example, computer system 800 may provide support for executing one or more virtual machines. In certain aspects, computer system 800 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 800. Accordingly, multiple operating systems may potentially be run concurrently by computer system 800.

Communications subsystem 824 provides an interface to other computer systems and networks. Communications subsystem 824 serves as an interface for receiving data from and transmitting data to other systems from computer system 800. For example, communications subsystem 824 may enable computer system 800 to establish a communication channel to one or more client devices via the Internet for receiving and sending information from and to the client devices. For example, the communications subsystem may be used to transmit a response to a user regarding the inquiry for a chatbot.

Communications subsystem 824 may support both wired and/or wireless communication protocols. For example, in certain aspects, communications subsystem 824 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 824 can provide wired network connectivity (e.g., Ethernet) in addition to or instead of a wireless interface.

Communications subsystem 824 can receive and transmit data in various forms. For example, in some aspects, in addition to other forms, communications subsystem 824 may receive input communications in the form of structured and/or unstructured data feeds 826, event streams 828, event updates 830, and the like. For example, communications subsystem 824 may be configured to receive (or send) data feeds 826 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 824 may be configured to receive data in the form of continuous data streams, which may include event streams 828 of real-time events and/or event updates 830, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 824 may also be configured to communicate data from computer system 800 to other computer systems or networks. The data may be communicated in various different forms such as structured and/or unstructured data feeds 826, event streams 828, event updates 830, and the like to one or more databases that may be in communication with one or more streaming data source computers coupled to computer system 800.

Computer system 800 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 800 depicted in FIG. 8 is intended only as a specific example. Many other configurations having more or fewer components than the system depicted in FIG. 8 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
accessing a stored data structure that represents a decision tree, wherein the decision tree is stored to make recommendations for unlabeled data based at least in part on a set of labeled training data, wherein the decision tree comprises a plurality of leaf nodes along a plurality of paths;
determining a plurality of rows of text based at least in part on the stored data structure, wherein each row of the plurality of rows represents a leaf node of the plurality of leaf nodes and comprises a plurality of conditions that describe a path to the leaf node along with a label for the leaf node, each condition of the plurality of conditions representing a branching node along a path to the leaf node; wherein the plurality of conditions are logically combined using a logical operator;
generating a prompt comprising the plurality of rows of text and a request to generate a result comprising a natural language summary column, wherein each row of the natural language summary column is requested to include a natural language summary of a corresponding path to a leaf node of the plurality of leaf nodes;
executing the prompt against a large language model;
receiving a particular result comprising a particular natural language summary column;
storing a first particular natural language summary of a first path from the particular natural language summary column in association with a first leaf node in the stored data structure; and
storing a second particular natural language summary of a second path from the particular natural language summary column in association with a second leaf node in the stored data structure.

2. The computer-implemented method of claim 1, wherein the prompt further includes a request to generate a natural language summary of a plurality of paths to leaf nodes of the plurality of leaf nodes,
wherein the particular result further comprises a narrative natural language summary, and wherein the method further comprises:
storing the narrative natural language summary in association with the stored data structure.

3. The computer-implemented method of claim 1, wherein the method further includes:
causing the display of a representation of the stored data structure, wherein the representation includes the first particular natural language summary displayed in association with the first leaf node.

4. The computer-implemented method of claim 1, wherein the prompt further comprises descriptions of a plurality of parameters for the conditions and a suggested condition to emphasize within the particular result.

5. The computer-implemented method of claim 1, wherein the decision tree of the stored data structure was generated using logic to maximize the homogeneity of samples in each child node.

6. The computer-implemented method of claim 1, wherein the prompt further comprises a description of a target table comprising the natural language summary column and a target table condition column to identify the condition for each of the natural language summaries of the natural language summary column.

7. The computer-implemented method of claim 1, wherein the method further comprises:
detecting a delimiter text between column names of the particular result;
determining the first particular natural language summary from the particular result based on the delimiter text.

8. A computer-program product comprising one or more non-transitory machine-readable storage media, including stored instructions configured to cause a computing system to perform a set of actions including:
accessing a stored data structure that represents a decision tree, wherein the decision tree is stored to make recommendations for unlabeled data based at least in part on a set of labeled training data, wherein the decision tree comprises a plurality of leaf nodes along a plurality of paths;
determining a plurality of rows of text based at least in part on the stored data structure, wherein each row of the plurality of rows represents a leaf node of the plurality of leaf nodes and comprises a plurality of conditions that describe a path to the leaf node along with a label for the leaf node, each condition of the plurality of conditions representing a branching node along a path to the leaf node; wherein the plurality of conditions are logically combined using a logical operator;
generating a prompt comprising the plurality of rows of text and a request to generate a result comprising a natural language summary column, wherein each row of the natural language summary column is requested to include a natural language summary of a corresponding path to a leaf node of the plurality of leaf nodes;
executing the prompt against a large language model;
receiving a particular result comprising a particular natural language summary column;
storing a first particular natural language summary of a first path from the particular natural language summary column in association with a first leaf node in the stored data structure; and
storing a second particular natural language summary of a second path from the particular natural language summary column in association with a second leaf node in the stored data structure.

9. The computer-program product of claim 8, wherein the prompt further includes a request to generate a natural language summary of a plurality of paths to leaf nodes of the plurality of leaf nodes,
wherein the particular result further comprises a narrative natural language summary, and wherein the set of actions further comprises:
storing the narrative natural language summary in association with the stored data structure.

10. The computer-program product of claim 8, wherein the set of actions further includes:
causing the display of a representation of the stored data structure, wherein the representation includes the first particular natural language summary displayed in association with the first leaf node.

11. The computer-program product of claim 8, wherein the prompt further comprises descriptions of a plurality of parameters for the conditions and a suggested condition to emphasize within the particular result.

12. The computer-program product of claim 8, wherein the decision tree of the stored data structure was generated using logic to maximize the homogeneity of samples in each child node.

13. The computer-program product of claim 8, wherein the prompt further comprises a description of a target table comprising the natural language summary column and a target table condition column to identify the condition for each of the natural language summaries of the natural language summary column.

14. The computer-program product of claim 8, wherein the set of actions further comprises:
detecting a delimiter text between column names of the particular result;
determining the first particular natural language summary from the particular result based on the delimiter text.

15. A system comprising:
one or more processors;
one or more non-transitory computer-readable media storing instructions, which, when executed by the system, cause the system to perform a set of actions including:
accessing a stored data structure that represents a decision tree, wherein the decision tree is stored to make recommendations for unlabeled data based at least in part on a set of labeled training data, wherein the decision tree comprises a plurality of leaf nodes along a plurality of paths;
determining a plurality of rows of text based at least in part on the stored data structure, wherein each row of the plurality of rows represents a leaf node of the plurality of leaf nodes and comprises a plurality of conditions that describe a path to the leaf node along with a label for the leaf node, each condition of the plurality of conditions representing a branching node along a path to the leaf node; wherein the plurality of conditions are logically combined using a logical operator;
generating a prompt comprising the plurality of rows of text and a request to generate a result comprising a natural language summary column, wherein each row of the natural language summary column is requested to include a natural language summary of a corresponding path to a leaf node of the plurality of leaf nodes;
executing the prompt against a large language model;
receiving a particular result comprising a particular natural language summary column;
storing a first particular natural language summary of a first path from the particular natural language summary column in association with a first leaf node in the stored data structure; and
storing a second particular natural language summary of a second path from the particular natural language summary column in association with a second leaf node in the stored data structure.

16. The system of claim 15, wherein the prompt further includes a request to generate a natural language summary of a plurality of paths to leaf nodes of the plurality of leaf nodes,
wherein the particular result further comprises a narrative natural language summary, and wherein the set of actions further comprises:
storing the narrative natural language summary in association with the stored data structure.

17. The system of claim 15, wherein the prompt further comprises descriptions of a plurality of parameters for the conditions and a suggested condition to emphasize within the particular result.

18. The system of claim 15, wherein the decision tree of the stored data structure was generated using logic to maximize the homogeneity of samples in each child node.

19. The system of claim 15, wherein the prompt further comprises a description of a target table comprising the natural language summary column and a target table condition column to identify the condition for each of the natural language summaries of the natural language summary column.

20. The system of claim 15, wherein the set of actions further comprises:
detecting a delimiter text between column names of the particular result;
determining the first particular natural language summary from the particular result based on the delimiter text.
